(19) United States
(12) Patent Application Publication
(10) Pub. No.: US 2026/0011107 A1
(43) Pub. Date: Jan. 8, 2026

(54) METHOD AND SYSTEM FOR IDENTIFYING FOREIGN OBJECT ON TRANSMISSION LINE, COMPUTER DEVICE, AND MEDIUM

(71) Applicant: Sichuan Siji Technology Co., Ltd., Chengdu (CN)

(72) Inventors: Donglai TANG, Chengdu (CN); Ming HE, Chengdu (CN); Lijie DING, Chengdu (CN); Wenkang CHEN, Chengdu (CN); Mei YANG, Chengdu (CN); Sheng ZHONG, Chengdu (CN); Zeyu CHEN, Chengdu (CN); Fei XIE, Chengdu (CN); Yiyu GONG, Chengdu (CN); Xiao NIE, Chengdu (CN); Guangzhi LIU, Chengdu (CN); Chuang DENG, Chengdu (CN); Le KANG, Chengdu (CN); Xu ZHONG, Chengdu (CN); Shijun FU, Chengdu (CN); Peng ZHOU, Chengdu (CN); Juli CHEN, Chengdu (CN); Shuyu HE, Chengdu (CN); Weisi LUO, Chengdu (CN); Qiming ZHANG, Chengdu (CN); Qiang MAO, Chengdu (CN); Yiqiu LI, Chengdu (CN); Linqian YU, Chengdu (CN); Shanshan YUAN, Chengdu (CN); Yi TANG, Chengdu (CN); Pan WANG, Chengdu (CN); Yi ZOU, Chengdu (CN)

(21) Appl. No.: 19/076,013

(22) Filed: Mar. 11, 2025

(30) Foreign Application Priority Data
Jul. 2, 2024 (CN) 202410873603.6

(51) Int. Cl. G06V 10/25; G06T 3/4053; G06T 3/60; G06T 5/50; G06T 5/70; G06T 7/12; G06V 10/44; G06V 10/74

(52) U.S. Cl. CPC G06V 10/25; G06T 3/4053; G06T 3/60; G06T 5/50; G06T 5/70; G06T 7/12; G06V 10/44; G06V 10/761; G06T 2207/20221; G06V 2201/07

(57) ABSTRACT

The present disclosure discloses a method and system for identifying a foreign object on a transmission line, a computer device, and a medium, and relates to the field of image identification technologies. According to the present disclosure, an impact of an environment on a transmission line inspection image is eliminated by using the super-resolution reconstruction defogging algorithm, then the transmission line image is semantically segmented by using an image segmentation algorithm to reduce an impact of a background image on identification of the foreign object on the transmission line, and finally, the foreign object on the transmission line is quickly and accurately identified according to the transmission line foreign object sample database constructed based on a segment anything model and an object morphological augmentation algorithm.

### CROSS-REFERENCE TO RELATED APPLICATION

This application claims the benefit of Chinese Patent Application No. 202410873603.6, filed Jul. 2, 2024, which is hereby incorporated by reference in its entirety including any tables, figures, or drawings.

### TECHNICAL FIELD

The present disclosure relates to the field of image recognition technologies, and in particular, to a method and system for identifying a foreign object on a transmission line, a computer device, and a medium.

### BACKGROUND

With the continuous development of information technology, a transmission line inspection technology based on an unmanned aerial vehicle and a video camera has gradually replaced a manual inspection technology. After obtaining an image of a transmission line, the unmanned aerial vehicle and the video camera upload the image to a background server to identify a foreign object on the transmission line. In the early days, a team for operation and maintenance of a transmission line identified a foreign object on the transmission line in a manner of manually viewing inspection images. Due to a large number of images and an impact of human factors and the like, missing inspection and the like are likely to occur during video image inspection, which leads to the problem of failing to identify a foreign object on the transmission line in a timely manner, thereby affecting operation safety of the transmission line.

Therefore, to solve the above problems existing in manual identification, a lot of research has been performed on an intelligent algorithm for identifying a foreign object on a transmission line at present. For example, (1) a technology for identifying a foreign object on a transmission line based on an improved YOLOv4 algorithm is provided, to generate an adaptive sample dataset through k-means clustering, and identify the foreign object on the transmission line through spatial pyramid pooling; (2) a technology for identifying a foreign object on a transmission line based on a convolutional neural network is provided, to identify a type of the foreign object on the transmission line by constructing four types of foreign objects on the transmission line, such as balloon, kite, plastic, and bird nest, and by using the convolutional neural network; (3) a technology for identifying a foreign object on a transmission line based on a Dense-net network is provided, to effectively identify intrusion of kites, bird nests, garbage, and mechanical construction foreign objects; and (4) a technology for identifying a foreign object on a transmission line based on Hough transform is provided, to identify a feature of the foreign object on the transmission line through Hough transform and a Hough transform accumulator. However, the transmission line crosses complex terrains such as mountains, rivers, and forests, and an image background is extremely easily confused with foreign objects on the transmission line. The above-mentioned existing transmission line anomaly recognition algorithms do not fully take this problem into account, resulting in low accuracy of image recognition of a foreign object on the transmission line.

### SUMMARY

To solve the problem that a transmission line background terrain is complex and a background image is extremely easily confused with a foreign object on the transmission line, which leads to low accuracy of image recognition of the foreign object on the transmission line, the present disclosure provides a method and system for identifying a foreign object on a transmission line, a computer device, and a medium. According to the present disclosure, an impact of an environment on a transmission line inspection image is eliminated by using a super-resolution reconstruction defogging algorithm, then a transmission line image is semantically segmented by using an image segmentation algorithm to reduce an impact of the background image on identification of the foreign object on the transmission line, and finally, the foreign object on the transmission line is quickly and accurately identified according to a transmission line foreign object sample database constructed based on a segment anything model and an object morphological augmentation algorithm.

The present disclosure is implemented by the following technical solutions:

A method for identifying a foreign object on a transmission line includes:

processing a collected transmission line image by using a super-resolution reconstruction defogging algorithm;

semantically segmenting a processed transmission line image by using a foreign object segmentation and extraction algorithm, to complete abnormal feature extraction; and

comparing an extracted abnormal feature image with an image in a transmission line foreign object sample database, to identify a type of the foreign object on the transmission line, where the transmission line foreign object sample database is constructed through a segment anything model and a morphological augmentation algorithm.

In some embodiments, the super-resolution reconstruction defogging algorithm processes the transmission line image through a pre-constructed and trained super-resolution reconstruction defogging model,

where a process of constructing and training the super-resolution reconstruction defogging model includes:

constructing a comparison dataset of an original normal image and weather image of the transmission line based on a collected historical transmission line image, and denoising the dataset, where the weather image refers to a transmission line image collected in abnormal weather, and the normal image refers to a transmission line image obtained in normal weather;

constructing the super-resolution reconstruction defogging model, where the constructed super-resolution reconstruction defogging model includes a super-resolution structure and a defogging structure, where by continuous sampling of the weather image, the super-resolution structure develops a feature map of the image from a low dimension to a high dimension, the model independently learns interpolated pixels based on image information, and an interpolated high-dimension feature map does not destroy original image information; starting from the high-dimension feature map, the defogging structure restores the normal image through a channel attention mechanism network structure; and

inputting the comparison dataset into the super-resolution reconstruction defogging model for training, and restoring perceived quality of the image by using a perceptual loss.

In some embodiments, the restoring the normal image through a channel attention mechanism network structure is specifically:

extracting a feature in each convolution kernel channel through a channel attention mechanism, compressing each channel into a point, and directly obtaining an average as a feature value of the channel, to implement image restoration.

In some embodiments, before the processing the transmission line image through a pre-constructed and trained super-resolution reconstruction defogging model, the method further includes:

denoising the collected transmission line image.

In some embodiments, the foreign object segmentation and extraction algorithm specifically includes:

segmenting a region of interest in the transmission line image by using an image segmentation model;

obtaining a multi-scale sample feature of a top1 feature from a memory module and a corresponding multi-scale feature of the image for channel dimension fusion; and

performing abnormal feature extraction on a feature-fused image by using a semi-supervised learning model.

In some embodiments, a process of identifying the type of the foreign object on the transmission line specifically includes:

calculating an image similarity between the abnormal feature image and the image in the transmission line foreign object sample database; and

determining the type of the foreign object on the transmission line based on the image similarity.

In some embodiments, a process of constructing the transmission line foreign object sample database specifically includes:

inputting a historical abnormal feature image into the segment anything model to generate a transmission line foreign object sample set;

screening an abnormal object on the transmission line foreign object sample set to select an abnormal generated target conforming to a power transmission scenario, extracting a target image in a stroke manner by using contour information in an annotation, and retaining the target image in an original dimension to form a foreign object target image dataset;

performing morphological augmentation on a foreign object target image in the foreign object target image dataset, including: performing random angle rotation and random flipping operations on the foreign object target image; randomly generating a perspective transformation matrix based on a pixel on a foreign object target, and performing perspective transformation to transform the foreign object target from one perspective to another; and

performing image fusion on a morphologically-augmented foreign object target image and a transmission line scenario image, where an image fusion process needs to meet: a boundary between the foreign object target image and the transmission line scenario image remains smooth; and the boundary between the foreign object target image and the transmission line scenario image is seamless.

According to a second aspect, the present disclosure provides a system for identifying a foreign object on a transmission line, including:

a super-resolution reconstruction defogging module, configured to process a collected transmission line image by using a super-resolution reconstruction defogging algorithm;

an anomaly segmentation and extraction module, configured to semantically segment a processed transmission line image by using a foreign object segmentation and extraction algorithm, to complete abnormal feature extraction; and

a foreign object type identification module, configured to compare an extracted abnormal feature image with an image in a transmission line foreign object sample database, to identify a type of the foreign object on the transmission line, where the transmission line foreign object sample database is constructed through a segment anything model and a morphological augmentation algorithm.

According to a third aspect, the present disclosure provides an electronic device, including a memory and a processor, where the memory stores a computer program, and when executing the computer program, the processor implements the steps of the method according to the present disclosure.

According to a fourth aspect, the present disclosure provides a computer-readable storage medium, where the computer-readable storage medium stores a computer program, and when executed by a processor, the computer program implements the steps of the method according to the present disclosure.

In the method and system for identifying a foreign object on a transmission line, the computer device, and the medium according to the present disclosure, an impact of transmission line environments such as rain, fog, snow, and haze on the transmission line inspection image is reduced by the super-resolution reconstruction defogging algorithm, then the transmission line image is semantically segmented by using the image segmentation algorithm to complete abnormal feature extraction and reduce an impact of the background image on identification of the foreign object on the transmission line, and finally, the foreign object on the transmission line is accurately and quickly identified based on a transmission line foreign object sample database constructed through the segment anything model and the object morphological augmentation algorithm. This solves the problem of low accuracy of image recognition of a foreign object on a transmission line caused by the facts that a transmission line environment is complex and a background image is extremely easily confused with the foreign object on the transmission line.

The method and system for identifying a foreign object on a transmission line, the computer device, and the medium according to the present disclosure can be applied to identification of the foreign object on the transmission line in various complex transmission line environments, and have high identification accuracy and reliability.

### BRIEF DESCRIPTION OF DRAWINGS

The accompanying drawings described herein are used to provide further understanding of embodiments of the present disclosure, and constitute a part of the present application, but does not constitute limitations to the embodiments of the present disclosure. In the accompanying drawings:

FIG. 1 is a flowchart of a method according to an embodiment of the present disclosure;

FIG. 2 is a diagram of a U-net network structure according to an embodiment of the present disclosure;

FIG. 3 is a block diagram of a principle of a system according to an embodiment of the present disclosure; and

FIG. 4 is a schematic architectural diagram of a computer device according to an embodiment of the present disclosure.

### DESCRIPTION OF EMBODIMENTS

To make the objectives, technical solutions, and advantages of the present disclosure clearer, the present disclosure is further described in detail below with reference to embodiments and the accompanying drawing. The schematic implementations of the present disclosure and descriptions thereof are only used to explain the present disclosure, but are not intended to limit the present disclosure.

### Embodiments

An existing technology for identifying a foreign object on a transmission line does not fully take a complex transmission line background terrain into account, and a background image is extremely easily confused with a foreign object on a transmission line, which leads to the problem of low accuracy of identifying the foreign object on the transmission line. Regarding this problem, this embodiment provides a method for identifying a foreign object on a transmission line. In the method for identifying a foreign object on a transmission line in this embodiment, an impact of a transmission line environment on a transmission line inspection image is fully taken into account, an impact of a background image on identification of the foreign object on transmission line is reduced, and finally high-precision identification of the foreign object on the transmission line is implemented by an object morphological augmentation algorithm.

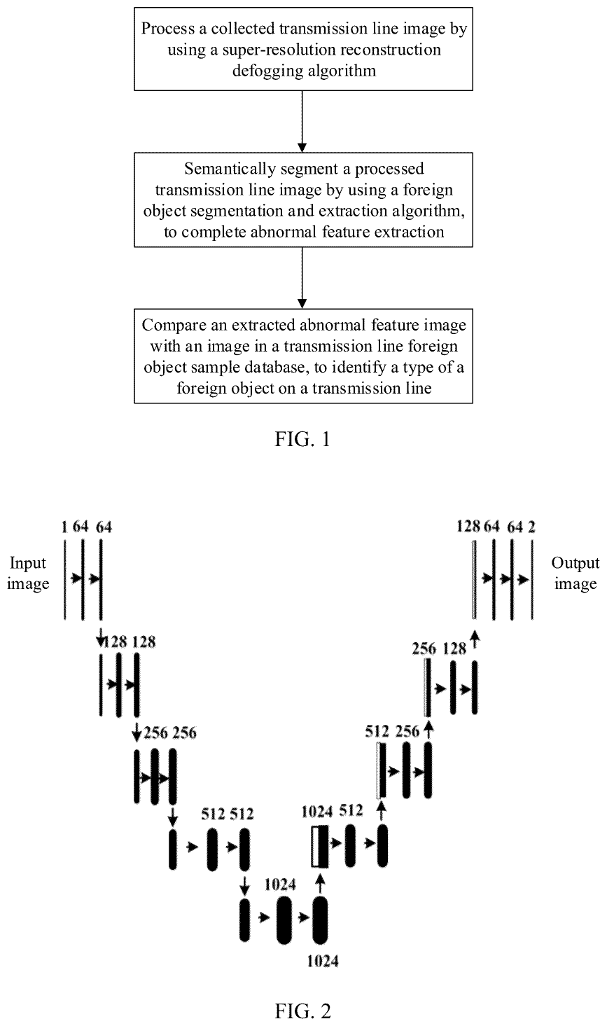

As shown in FIG. 1, the method for identifying a foreign object on a transmission line in this embodiment specifically includes the following steps.

Step 100: Process a collected transmission line image by using a super-resolution reconstruction defogging algorithm.

To ensure that an algorithm for identifying a foreign object on a transmission line can implement all-weather foreign object identification, the super-resolution reconstruction defogging algorithm is used in step 100, to restore a transmission line image collected on a rainy day, a foggy day, a hazy day, a snowy day, or the like to an image in normal weather, so as to reduce an impact of an environment such as rain, fog, or snow on a transmission line inspection image, and provide a more reliable transmission line image for subsequent steps.

Optionally, in step 100, the transmission line image is processed through a pre-constructed and trained super-resolution reconstruction defogging model, to reduce the impact of the environment on the transmission line image and provide a more reliable data source for subsequent anomaly identification. A process of constructing and training the super-resolution reconstruction defogging model specifically includes:

Step 101: Data preparation and preprocessing: Construct a comparison dataset of an original normal image and weather image of the transmission line based on a collected historical transmission line image, use the comparison dataset as an evaluation benchmark for super-resolution reconstruction defogging, and denoise the dataset to eliminate an impact of noise on image recognition. The weather image refer to a transmission line image collected in abnormal weather such as rain, fog, haze, or snow. The normal image refer to a transmission line image collected in normal weather.

Step 102: Construct a super-resolution reconstruction defogging model, where the constructed super-resolution reconstruction defogging model includes two parts: a super-resolution structure and defogging structure. By continuous sampling of the weather image, the super-resolution structure develops a feature map of the image from a low dimension to a high dimension, the model independently learns interpolated pixels based on image information, and an interpolated high-dimension feature map does not destroy original image information. Starting from the high-dimension feature map, the defogging structure restores the normal image through a channel attention mechanism network structure, and restores details, luminosity and color changes of various objects in a transmission line scenario.

A feature in each convolution kernel channel is extracted through a channel attention mechanism, each channel is compressed into a point, and an average is directly obtained as a feature value of the channel, to implement image restoration. A channel defogging result of the super-resolution reconstruction defogging model of the transmission line image is expressed as follows:

$${e}^{ZC} = \frac{1}{{l}^{H} * {l}^{W}} \text{?}$$

$$\text{?} \text{indicates text missing or illegible when filed}$$

where e^{ZC} denotes a channel defogging result, and l^{H} and l^{W} are a length and a width of a channel attention mechanism feature map channel; βᵢₖ is a different feature graph channel; and sum is a summation function.

Step 103: Training the super-resolution reconstruction defogging model: After the construction of the super-resolution reconstruction defogging model is completed, input a corresponding weather image and original normal image for training, and restore perceived quality of the image by using a perceptual loss. The perceptual loss takes similarities in color, contrast and structure into account. Compared with a conventional pixel-level loss, the perceptual loss can generate an image with more visual perceived quality. In addition, due to the use of high-level feature representation, the perceptual loss has a generalization ability to a certain extent, and is not susceptible to over-fit to specific training data. Through training, a desired defogging effect is finally achieved.

Then the trained super-resolution reconstruction defogging model may be used to defog and restore a transmission line image collected in real time, to reduce an impact of weather and other factors on identification of the foreign object on the transmission line, thereby improving accuracy of identifying the foreign object on the transmission line. Optionally, before the transmission line image collected in real time is defogged and restored, the transmission line image further needs to be denoised to eliminate an impact of noise on image recognition.

Step 200: Semantically segment a processed transmission line image by using a foreign object segmentation and extraction algorithm, to complete abnormal feature extraction.

In step 200, the transmission line image is semantically segmented by using the foreign object segmentation and extraction algorithm, to reduce an impact of the background image on identification of the foreign object on the transmission line and further improve accuracy of identification. Optionally, the foreign object segmentation and extraction algorithm used in step 200 specifically includes:

Step 201: Location of a key region: Segment a region of interest in the transmission line image by using an image segmentation model. The image segmentation model may use a U-net network structure, which introduces skip connection to greatly improve accuracy of image segmentation. Specifically, the U-net network structure includes three parts: an encoder, a decoder, and a bottleneck layer, as shown in FIG. 2. The encoder includes four parts (as shown in the left part of FIG. 2), each being composed of two 3*3 convolutional layers using a Relu activation function and one 2*2 pooling layer for downsampling. The decoder includes four parts (as shown in the right part of FIG. 2), each being composed of one 2*2 deconvolutional layer and two 3*3 convolutional layers using a Relu activation function for upsampling. The bottleneck layer (that is, a front end part of an output image in FIG. 2) is composed of two 3*3 convolutional layers using a Relu activation function and one 1*1 convolutional layer, and a final output image is obtained.

The image segmentation model may be obtained through training by the U-net network structure by using a small number of historical transmission line image sample sets, which can predict a pixel edge category, thereby segmenting the region of interest in the image.

An anchor box method is used to divide a bounding box of the transmission line. The anchor box method is a method of dividing a boundary of an image region, which takes the transmission line as a center, generates a plurality of bounding boxes with different scaling ratios and aspect ratios, that is, multi-scale input sample features, and features fast division speed, and the like. Specifically, a transmission line anchor box takes the transmission line as the center, and a width and a height of the anchor box are as follows:

$$\{ \begin{matrix}w = o \sqrt{HWz} \\ h = o \sqrt{\frac{WH}{z}}\end{matrix}$$

where w and h are the width and the height of the anchor box; W and H are input images of the transmission line; o is a scaling ratio of a transmission line image; and z is an aspect ratio of the transmission line image.

Step 202: Feature fusion: Obtain a multi-scale sample feature of a top1 feature from a memory module and a corresponding multi-scale feature of the image for channel dimension fusion. Specifically, 4×, 8× and 16× multi-scale sample features of a top1 feature that are obtained from a memory module and input sample features are subject to channel dimension fusion according to 4×, 8× and 16× multi-scale features of the image. To improve robustness of a detection model, diverse fusion operators may be used, for example, differential fusion according to differences, weighted fusion with prominent features, and the like may be used. After the fusion, an attention mechanism in deep learning is introduced to adjust an attention weight of an image channel to focus on a difference in a feature dimension.

Step 203: Abnormal feature extraction: Continue to perform abnormal feature extraction on information after the feature fusion. In this embodiment, the abnormal feature extraction is performed by using a semi-supervised learning (SSL) model. The semi-supervised learning model may use a manner of fusion training of labeled and unlabeled transmission line foreign object samples, which can reduce the workload of transmission line image labeling. During training of the semi-supervised learning model, taking a minimum mean squared error (MSE) as a goal, when there are more training times, the transmission line image converges. The mean squared error D_{MSE} is:

$${D}_{MSE} = \frac{1}{{m}_{d}} \text{?} {( {F}_{j} - {Z}_{j} )}^{2}$$

$$\text{?} \text{indicates text missing or illegible when filed}$$

where m_{d} is a quantity of transmission line images; Fⱼ is a predicted value of an abnormal feature of a j^{th} transmission line image; and Zⱼ is a true value of the abnormal feature of the j^{th} transmission line image.

Step 300: Compare an extracted abnormal feature image with an image in a transmission line foreign object sample database, to identify a type of the foreign object on the transmission line. The transmission line foreign object sample database is constructed through a segment anything model and a morphological augmentation algorithm.

Optionally, in this embodiment, a similarity algorithm may be used to compare the abnormal feature image with the image in the transmission line foreign object sample database. That is, a similarity between the abnormal feature image and the image in the transmission line foreign object sample database is calculated, and the type of the foreign object is determined based on the similarity. Specifically, an image similarity calculation method is as follows:

$${e}_{cd} = {\sum }_{j = 1}^{m} \frac{1}{{u}_{j} {v}_{j}} {\sum }_{k = 1}^{n} {‖ {ω}_{k} \cdot ( {x}_{ak} - {x}_{bk} ) ‖}_{2}^{2}$$

where e_{cd} is a similarity value; m is a quantity of PIPS (Perceptual Image Patch Similarity) layers of the transmission line foreign object image; n is a weight quantity of each PIPS layer of the transmission line foreign object image; uⱼ is a training weight of a j^{th} layer of the transmission line foreign object image; vⱼ is a mapping score of the j^{th} layer of the transmission line foreign object image; and ωₖ is a k^{th} weight of PIPS layers of the transmission line foreign object image. xₐₖ and yₐₖ denote normalized values of a current transmission line foreign object image and a transmission line foreign object image sample after feature extraction.

A dataset generated by the segment anything model (SAM) has a huge amount of data and very rich data types. In addition, labeling information of each target is relatively perfect, so it is very suitable for meeting requirements for generation of an abnormal sample set in this embodiment. Therefore, in this embodiment, the segment anything model is used to establish a transmission line foreign object sample set, and various morphological and color changes of foreign objects are expanded by a target morphological augmentation algorithm, so as to construct a transmission line foreign object sample database and accurately identify the foreign objects on the transmission line. Specifically, a process of constructing the transmission line foreign object sample database specifically includes:

Step 301: Foreign object target screening: Input a historical abnormal feature image into the SAM to generate a transmission line foreign object sample set. To be as close to a real foreign object case as possible, abnormal objects need to be screened to select an abnormal target conforming to a power transmission scenario. Considering that objects hanging on the transmission line are generally light in weight, and the foreign objects each are in the form of a cloth or a rope, which can surround the transmission line, the transmission line foreign object sample set is obtained after statistics. There are multiple objects that meet features of foreign objects on a high-altitude transmission line. Dust screens, clothes, films, and other objects are selected as foreign objects to generate intruding objects. A target image is extracted in a stroke manner by using contour information in an annotation, and the target image is saved in an original dimension to form a target image dataset for use in subsequent steps.

Step 302: Object morphological augmentation of foreign objects: After screening of objects is completed, the obtained foreign object target image dataset almost covers all foreign objects that may appear on the high-altitude line. Considering that foreign objects are different not only in type, but also in morphology, to make morphologies more diverse, a morphological augmentation algorithm is used in this step to be applied to morphological expansion of foreign object targets, so that abnormal targets are more diverse. The dimensions of the abnormal objects are equally scaled to a certain pixels to ensure that no too large foreign objects appear in a generated high-altitude foreign object image, which is closer to reality.

Random angle rotation and random flipping operation are performed on the foreign object target image to simulate various morphologies of suspended objects on the transmission line.

A perspective transformation matrix is randomly generated based on a pixel on an abnormal object, and perspective transformation is performed to transform the object from one perspective to another, to simulate the morphology of the suspended object on the transmission line in terms of distance.

After the above operations, abnormal objects become more diverse, and an identification model becomes more robust and generalizable due to morphological augmentation.

Step 303: Object background fusion: After screening of abnormal objects (foreground) is completed and morphological augmentation is completed, image fusion needs to be performed with the transmission line scenario (background). To make a fusion effect closer to reality, factors in two aspects need to be considered when a foreground image (that is, a foreign object target image) is placed on a background image: (1) a boundary between the foreground image and the background image should remain smooth as far as possible; and (2) the boundary between the foreground image and the background image is seamless, that is, pixel values of the foreground image and the background image at boundary points need to remain consistent on the boundary.

The above factors in two aspects can be understood as the same gradient of the foreground image and the background image and the same pixel value on the boundary. Remaining smooth may be expressed as:

$${min}_{f} \int {\int }_{δ}^{} {\vert ∇ f - v \vert}^{2}$$

where δ denotes a region covered by foreground after image fusion, f denotes a pixel function within δ after the image fusion, v denotes a gradient field of a foreground image region, and ∇ denotes a gradient operator.

Remain consistent on the boundary may be expressed as:

$$f \text{?} = \text{?}$$

$$\text{?} \text{indicates text missing or illegible when filed}$$

where f* denotes a pixel function outside δ after the image fusion. The above can be simplified as solving a Poisson's equation in discrete space, and after the solving, an optimal fusion state of foreground and background can be obtained. After the fusion, a transmission line foreign object sample database composed of foreign object target images of multiple morphologies and multiple types is obtained.

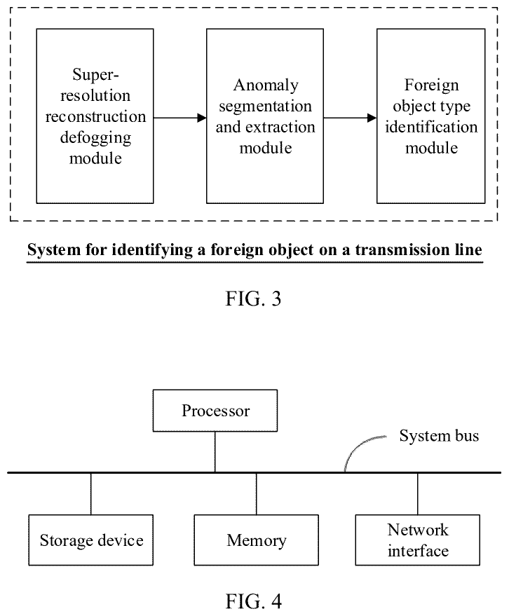

This embodiment further provides a system for identifying a foreign object on a transmission line. As shown in FIG. 3, the system in this embodiment specifically includes:

a super-resolution reconstruction defogging module, configured to process a collected transmission line image by using a super-resolution reconstruction defogging algorithm, where a specific processing process of the super-resolution reconstruction defogging module is described in step 100 of the foregoing method, and details are not described herein;

an anomaly segmentation and extraction module, configured to semantically segment a processed transmission line image by using a foreign object segmentation and extraction algorithm, to complete abnormal feature extraction, where a specific processing process of the anomaly segmentation and extraction module is described in step 200 of the foregoing method, and details are not described herein; and

a foreign object type identification module, configured to compare an extracted abnormal feature image with an image in a transmission line foreign object sample database, to identify a type of the foreign object on the transmission line. The transmission line foreign object sample database is constructed through a segment anything model dataset and a morphological augmentation algorithm. A specific processing process of the foreign object type identification module and a process of constructing the transmission line foreign object sample database are described in step 300 of the foregoing method, and details are not described herein.

Optionally, the system in this embodiment further includes:

a data collection module, configured to collect the transmission line image by using an unmanned aerial vehicle or an image obtaining apparatus.

An embodiment further provides a computer device, configured to perform the foregoing method in this embodiment.

Specifically, as shown in FIG. 4, the computer device includes a processor, a memory, and a system bus. Various device components, including the memory and the processor, are connected to the system bus. The processor is hardware configured to execute a computer program instruction by using a basic arithmetic and logical operation in a computer system. The memory is a physical device for temporarily or permanently storing a computing program or data (for example, program status information). The system bus may be any one of the following several types of bus structures, including a memory bus or a storage controller, a peripheral bus, and a local bus. The processor and the memory may perform data communication by using the system bus. The memory includes a read-only memory (ROM) or a flash memory (not shown in the figure), and a random access memory (RAM). The RAM is generally a main memory loaded with an operating system and a computer program.

The computer device generally includes a storage device. The storage device may be selected from a plurality of computer-readable media. The computer-readable medium is any available medium that can be accessed by using the computer device, including two types of media: a mobile medium and a fixed medium. For example, the computer-readable medium includes, but is not limited to, a flash memory (micro SD card), a CD-ROM, a digital versatile disc (DVD) or another optical disc storage, a magnetic tape cassette, a magnetic tape, a magnetic disk storage, or another magnetic storage device, or any other medium that may be used to store required information and that can be accessed by the computer device.

The computer device may be logically connected to one or more network terminals in a network environment. The network terminal may be a personal computer, a server, a router, a smartphone, a tablet computer, or another public network node. The computer device is connected to the network terminal through a network interface (local area network LAN interface). The local area network (LAN) is a computer network that is interconnected in a limited area, such as a home, a school, a computer laboratory, or an office building that uses network media. Wi-Fi and twisted pair cabling Ethernet are the two most commonly used technologies for constructing LAN.

It should be noted that another computer system including more or fewer subsystems than the computer device may also be applicable to the present disclosure.

As described in detail above, the computer device applicable to this embodiment can perform specified operations of the foregoing method for identifying a foreign object on a transmission line. The computer device performs these operations by running software instructions in the computer-readable medium by using the processor. These software instructions may be read into a memory from a storage device or from another device through a local area network interface. The software instructions stored in the memory cause the processor to perform the foregoing method for identifying a foreign object on a transmission line. In addition, the present disclosure may also be implemented by using a hardware circuit or a hardware circuit in combination with software instructions. Therefore, implementation of this embodiment is not limited to a combination of any specific hardware circuit and software.

The objectives, technical solutions, and beneficial effects of the present disclosure are further described in detail in the foregoing specific implementations. It should be understood that the foregoing descriptions are merely specific implementations of the present disclosure and are not intended to limit the protection scope of the present disclosure. Any modification, equivalent replacement, improvement, and the like made within the spirit and principle of the present disclosure shall fall within the protection scope of the present disclosure.

What is claimed is:

1. A method for identifying a foreign object on a transmission line, comprising:
processing a collected transmission line image by using a super-resolution reconstruction defogging algorithm;
semantically segmenting a processed transmission line image by using a foreign object segmentation and extraction algorithm, to complete abnormal feature extraction; and
comparing an extracted abnormal feature image with an image in a transmission line foreign object sample database, to identify a type of the foreign object on the transmission line, wherein the transmission line foreign object sample database is constructed through a segment anything model and a morphological augmentation algorithm; and the super-resolution reconstruction defogging algorithm processes the transmission line image through a pre-constructed and trained super-resolution reconstruction defogging model,
wherein a process of constructing and training the super-resolution reconstruction defogging model comprises:
constructing a comparison dataset of an original normal image and weather image of the transmission line based on a collected historical transmission line image, and denoising the dataset, wherein the weather image refers to a transmission line image collected in abnormal weather, and the normal image refers to a transmission line image obtained in normal weather;
constructing the super-resolution reconstruction defogging model, wherein the constructed super-resolution reconstruction defogging model comprises a super-resolution structure and a defogging structure, wherein by continuous sampling of the weather image, the super-resolution structure develops a feature map of the image from a low dimension to a high dimension, the model independently learns interpolated pixels based on image information, and an interpolated high-dimension feature map does not destroy original image information;
starting from the high-dimension feature map, the defogging structure restores the normal image through a channel attention mechanism network structure; and
inputting the comparison dataset into the super-resolution reconstruction defogging model for training, and restoring perceived quality of the image by using a perceptual loss;
wherein the foreign object segmentation and extraction algorithm specifically comprises:
segmenting a region of interest in the transmission line image by using an image segmentation model;
obtaining a multi-scale sample feature of a top1 feature from a memory module and a corresponding multi-scale feature of the image for channel dimension fusion; and
performing abnormal feature extraction on a feature-fused image by using a semi-supervised learning model; and
wherein a process of constructing the transmission line foreign object sample database specifically comprises:
inputting a historical abnormal feature image into the segment anything model to generate a transmission line foreign object sample set;
screening an abnormal object on the transmission line foreign object sample set to select an abnormal generated target conforming to a power transmission scenario, extracting a target image in a stroke manner by using contour information in an annotation, and retaining the target image in an original dimension to form a foreign object target image dataset;
performing morphological augmentation on a foreign object target image in the foreign object target image dataset, comprising: performing random angle rotation and random flipping operations on the foreign object target image; randomly generating a perspective transformation matrix based on a pixel on a foreign object target, and performing perspective transformation to transform the foreign object target from one perspective to another; and
performing image fusion on a morphologically-augmented foreign object target image and a transmission line scenario image, wherein an image fusion process needs to meet: a boundary between the foreign object target image and the transmission line scenario image remains smooth; and the boundary between the foreign object target image and the transmission line scenario image is seamless.

2. The method for identifying a foreign object on a transmission line according to claim 1, wherein the restoring the normal image through a channel attention mechanism network structure is specifically:
extracting a feature in each convolution kernel channel through a channel attention mechanism, compressing each channel into a point, and directly obtaining an average as a feature value of the channel, to implement image restoration.

3. The method for identifying a foreign object on a transmission line according to claim 1, wherein before the processing the transmission line image through a pre-constructed and trained super-resolution reconstruction defogging model, the method further comprises:
denoising the collected transmission line image.

4. The method for identifying a foreign object on a transmission line according to claim 1, wherein a process of identifying the type of the foreign object on the transmission line specifically comprises:
calculating an image similarity between the abnormal feature image and the image in the transmission line foreign object sample database; and
determining the type of the foreign object on the transmission line based on the image similarity.

5. A system for identifying a foreign object on a transmission line, comprising:
a super-resolution reconstruction defogging module, configured to process a collected transmission line image by using a super-resolution reconstruction defogging algorithm;
an anomaly segmentation and extraction module, configured to semantically segment a processed transmission line image by using a foreign object segmentation and extraction algorithm, to complete abnormal feature extraction; and
a foreign object type identification module, configured to compare an extracted abnormal feature image with an image in a transmission line foreign object sample database, to identify a type of the foreign object on the transmission line, wherein the transmission line foreign object sample database is constructed through a segment anything model and a morphological augmentation algorithm; and
the super-resolution reconstruction defogging algorithm processes the transmission line image through a pre-constructed and trained super-resolution reconstruction defogging model,
wherein a process of constructing and training the super-resolution reconstruction defogging model comprises:
constructing a comparison dataset of an original normal image and weather image of the transmission line based on a collected historical transmission line image, and denoising the dataset, wherein the weather image refers to a transmission line image collected in abnormal weather, and the normal image refers to a transmission line image obtained in normal weather;
constructing the super-resolution reconstruction defogging model, wherein the constructed super-resolution reconstruction defogging model comprises a super-resolution structure and a defogging structure, wherein by continuous sampling of the weather image, the super-resolution structure develops a feature map of the image from a low dimension to a high dimension, the model independently learns interpolated pixels based on image information, and an interpolated high-dimension feature map does not destroy original image information; starting from the high-dimension feature map, the defogging structure restores the normal image through a channel attention mechanism network structure; and
inputting the comparison dataset into the super-resolution reconstruction defogging model for training, and restoring perceived quality of the image by using a perceptual loss;
wherein the foreign object segmentation and extraction algorithm specifically comprises:
segmenting a region of interest in the transmission line image by using an image segmentation model;
obtaining a multi-scale sample feature of a top1 feature from a memory module and a corresponding multi-scale feature of the image for channel dimension fusion; and
performing abnormal feature extraction on a feature-fused image by using a semi-supervised learning model; and
wherein a process of constructing the transmission line foreign object sample database specifically comprises:
inputting a historical abnormal feature image into the segment anything model to generate a transmission line foreign object sample set;
screening an abnormal object on the transmission line foreign object sample set to select an abnormal generated target conforming to a power transmission scenario, extracting a target image in a stroke manner by using contour information in an annotation, and retaining the target image in an original dimension to form a foreign object target image dataset;
performing morphological augmentation on a foreign object target image in the foreign object target image dataset, comprising: performing random angle rotation and random flipping operations on the foreign object target image; randomly generating a perspective transformation matrix based on a pixel on a foreign object target, and performing perspective transformation to transform the foreign object target from one perspective to another; and
performing image fusion on a morphologically-augmented foreign object target image and a transmission line scenario image, wherein an image fusion process needs to meet: a boundary between the foreign object target image and the transmission line scenario image remains smooth; and the boundary between the foreign object target image and the transmission line scenario image is seamless.

6. An electronic device, comprises a memory and a processor, wherein the memory stores a computer program, wherein when executing the computer program, the processor implements the steps of the method according to claim 1.
